(19) United States
(12) Patent Application Publication
(10) Pub. No.: US 2009/0317655 A1
(43) Pub. Date: Dec. 24, 2009

(54) NANOIMPRINT LITHOGRAPHY USING A LOCALIZED HEAT SOURCE

(75) Inventors: Rene J.M. Van de Veerdonk, Wexford, PA (US); Thomas F. Ambrose, Sewickley, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/143,909

(22) Filed: Jun. 23, 2008

(51) Int. Cl. B21D 13/00; B28B 11/08; H05B 7/00

(52) U.S. Cl. 428/603; 264/293; 264/484

(57) ABSTRACT

A method is disclosed that includes providing a substrate having a resist adheringly disposed thereon, providing a heat source adjacent to the resist, and activating the heat source while providing a topographically patterned template pressed against the resist. The heat source and the resist are disposed between the substrate and the template, such that the heat source provides a localized application of heat to the resist while the topographically patterned template is pressed against the resist.

### BACKGROUND

An overarching theme of research and development involving electronic components has been to fit ever more performance capabilities into packages of increasingly smaller scales. For example, research and development in microfabrication has been progressing along a series of technology nodes represented by increasingly smaller feature sizes, such as scales smaller than 45 nanometers. Nanoimprint lithography has been among the fabrication techniques that have helped continue this progress to smaller scale component fabrication.

In a typical example of nanoimprint lithography, a substrate is coated with a resist and a template is placed in high-pressure contact with the resist while the substrate and the template are heated above the glass transition temperature of the resist. The resist is mechanically imprinted to conform to the topography of the template. The resist solidifies upon cooling, the template is removed, and the resist coats the substrate in the imprinted topographic pattern. Additional processing steps may subsequently be used. However, it remains a significant challenge to ensure the precision of any fabrication technique on scales of only tens of nanometers or smaller.

### SUMMARY

Methods, systems and devices for improved and more precise nanoimprint lithography are disclosed herein. One illustrative method includes providing a substrate having a resist adheringly disposed thereon, providing a heat source adjacent to the resist, and activating the heat source while providing a topographically patterned template pressed against the resist. The heat source and the resist are disposed between the substrate and the template, such that the heat source provides a localized application of heat to the resist while the topographically patterned template is pressed against the resist.

Other features and benefits that characterize various embodiments will be apparent from the following detailed description, the associated drawings, and the other disclosure herein.

### BRIEF DESCRIPTION OF THE DRAWINGS

FIG. 1 depicts a time-ordered sequence of steps performed with a system according to an illustrative embodiment.

FIG. 2 depicts a flowchart for a method according to an illustrative embodiment.

FIG. 3 depicts a flowchart for a method according to an illustrative embodiment.

### DETAILED DESCRIPTION

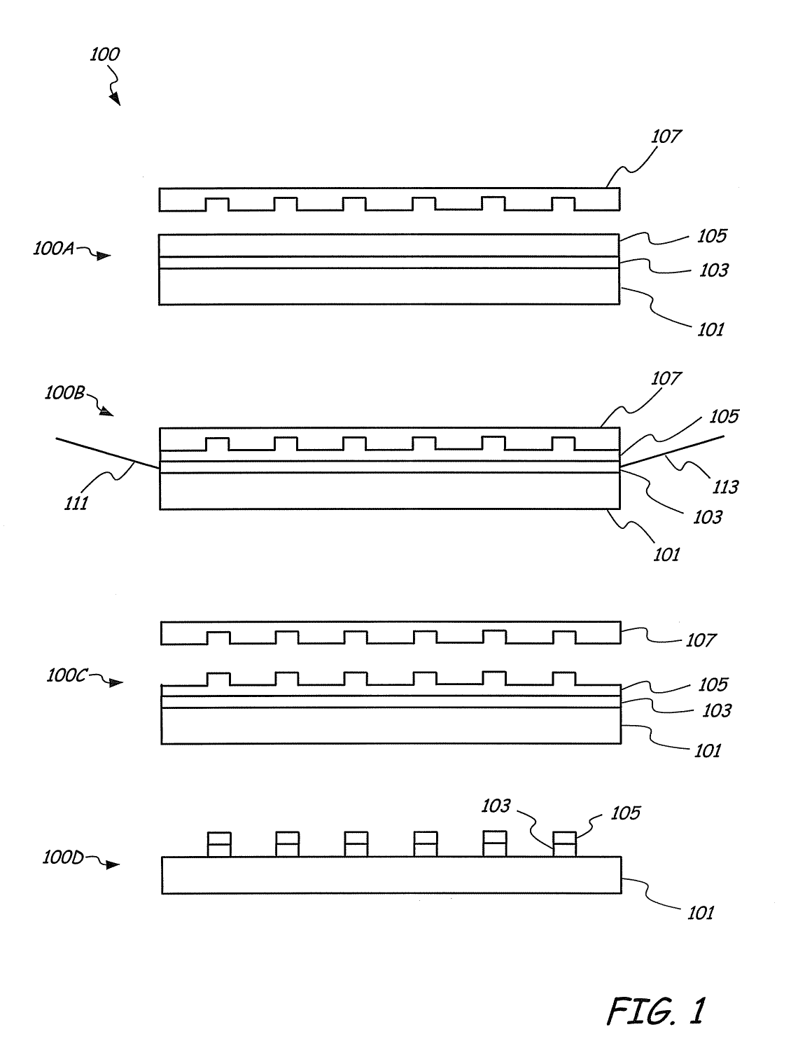

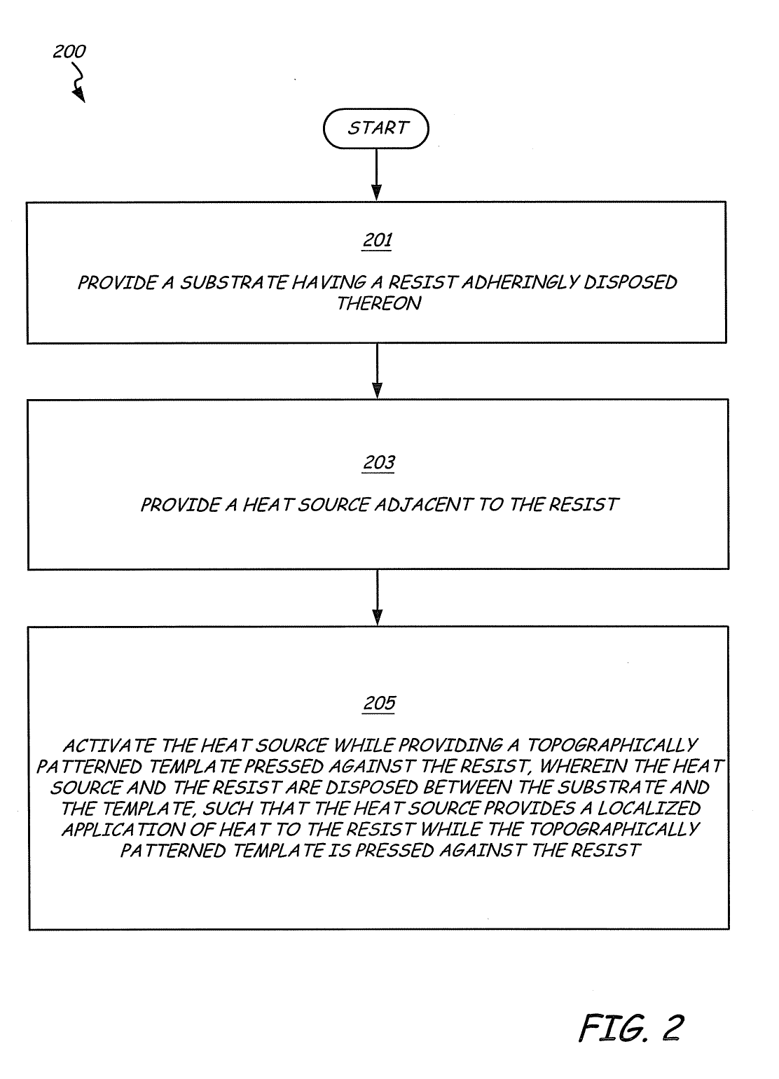

FIG. 1 depicts a system 100 in a simplified view as it progresses through a time-ordered sequence of processing stages 100A through 100D, according to an illustrative embodiment. System 100 includes various inventive elements that provide substantial advantages in performance, as detailed with reference to FIG. 1 and the remaining figures. FIG. 2 depicts a flowchart for a method 200 that includes a series of steps corresponding to the changes made to system 100 as depicted in FIG. 1, according to one illustrative embodiment

Method 200 includes step 201 of providing a substrate having a resist adheringly disposed thereon, and step 203, of providing a heat source adjacent to the resist. Accordingly, FIG. 1 depicts system 100 initially in the form indicated at processing stage 100A, which includes a substrate 101 having a multilayered foil 103 and a resist 105 adheringly disposed on substrate 101. Substrate 101 may, for example, be a glass disc, an aluminum disc, or a high-purity silicon wafer, among other options, and may have any number and type of layers already deposited thereon, that may have been patterned with any different lithographic or other patterning processes.

Multilayered foil 103 constitutes one illustrative example of a heat source disposed on substrate 101 adjacent to resist 105. Multilayered foil 103 may be composed of two or more substances that are capable of reacting with each other exothermically, in an illustrative embodiment. For example, this may include a transition metal and a light element. In one illustrative example, this may include several alternating, sandwiched layers of nickel and aluminum.

System 100A also includes a template 107 which includes a topographical pattern, as seen, in a simplified depiction, on the face of template 107 facing toward resist 105. A positioning component (not depicted in FIG. 1) may be configured to press the template 107 into contact with the resist 105, which is explained below with reference to the system 100 as it is subsequently developed, as depicted at processing stage 100B. This and other subsequent changes made to system 100 in processing stages 100B through 100D are further explained with reference to FIG. 2.

Method 200 of FIG. 2 also includes step 205 of activating the heat source while providing a topographically patterned template pressed against the resist. This is depicted for system 100 in FIG. 1 at processing stage 100B. The heat source, in this case multilayered foil 103, and the resist 105 are both disposed between the substrate 101 and the template 107. Electrical leads 111, 113 are positioned to contact the multilayered foil 103 while the template 107 is being pressed into contact with the resist 105. Electrical leads 111, 113 may then be used to deliver a voltage to multilayered foil 103, which ignites an exothermic reaction in multilayered foil 103.

By undergoing this exothermic reaction, multilayered foil 103 acts as a heat source that provides a localized application of heat to the resist 105 while the topographically patterned template 107 is pressed against the resist 105. The heat deforms or melts resist 105 while it is being impressed upon by template 107, thereby causing resist 105 to deform or flow into conformity with the topographic pattern on template 107, before subsequently cooling and solidifying in this topographically patterned form.

As provided by multilayered foil 103 in this illustrative embodiment, this source of heat is localized in that it is exerted in contact with resist 105 and is able to heat resist 105 and the part of template 107 in close proximity with the template's contact with resist 105. At the same time, the heat is delivered very quickly and then diffuses away very quickly in this illustrative embodiment, so that it does not have the chance to continue heating template 107 enough to deliver a significant amount of heat to the entire body of template 107, but instead only to those portions of it in contact or particularly close proximity to resist 105.

Because of the localized position of the heat source, the resist can be raised to the proper temperature with a substantially lower amount of heat, and in a substantially shorter period of time, compared with traditional systems. This means also that the heat diffuses away substantially more quickly than in traditional systems, and does not deliver enough heat to the template to substantially raise the temperature across the main body of the template.

This localization and then rapid diffusion of the heat provide substantial advantages in ensuring more precise microfabrication, or fabrication on microscopic and smaller scales, such as in the tens of nanometers. In a typical traditional technique, the entire template experiences some heating, and experiences thermal mismatches and/or temperature gradients, including during the cooling process. These thermal mismatches and temperature gradients in the template in turn cause differences in linear thermal expansion coefficients and cause defects in the topographic patterns as imprinted from the template onto the resist.

On the other hand, the illustrative embodiments discussed above and depicted in FIGS. 1 and 2 prevent these defects. The heating of the resist 105 and subsequent diffusion of the heat both take place so rapidly that they only heat the parts of the template 107 that need to be heated, those parts that are in immediate contact with the resist 105, while the bulk of template 107 remains at an essentially constant temperature. By keeping the bulk of the template 107 at an essentially constant temperature, thermal mismatches and temperature gradients are prevented, in this illustrative embodiment.

Avoiding these thermal mismatches and temperature gradients using this localized heat source thereby ensures that the topographic patterns are imprinted on the resist more precisely. This greater precision also enables the reliable creation of features of a smaller scale, enabling a greater density of topographic features, and therefore more capabilities within a smaller and lighter package.

It will be readily understood that the concept of absolute constancy of temperature is never likely and not even well-defined for macroscopic objects, but a substantial portion of template 107 remains at an essentially constant temperature in that this portion does not have its temperature appreciably raised by the temporary heating of the resist and the portion of template 107 in immediate contact with the resist. Put another way, its temperature is not raised enough that it would have effects that could be confidently measured to be outside of the normal variations in temperature that might generally be statistically expected in a fabrication context—or more than a few degrees, in one illustrative example.

FIG. 1 also depicts system 100 at processing stage 100C, where the template 107 is removed from contact with resist 105 once resist 105 has cooled enough to re-solidify; and processing stage 100D, representing system 100 after further processing steps that have further defined features in the substrate 101 and resist 105. Substrate 101 may go through any number of other processing steps as part of a process of fabricating any type of device. The substrate 101 may form the main body of a wafer which also includes the patterned resist 105 and which may also include a wide variety of other layers and components resulting from such additional processing steps. Those processing steps may include one or more of descumming, etching, deposition, planarization, lithography, doping, and annealing, for example, and any of a wide variety of specific techniques encompassed within these general types of processes.

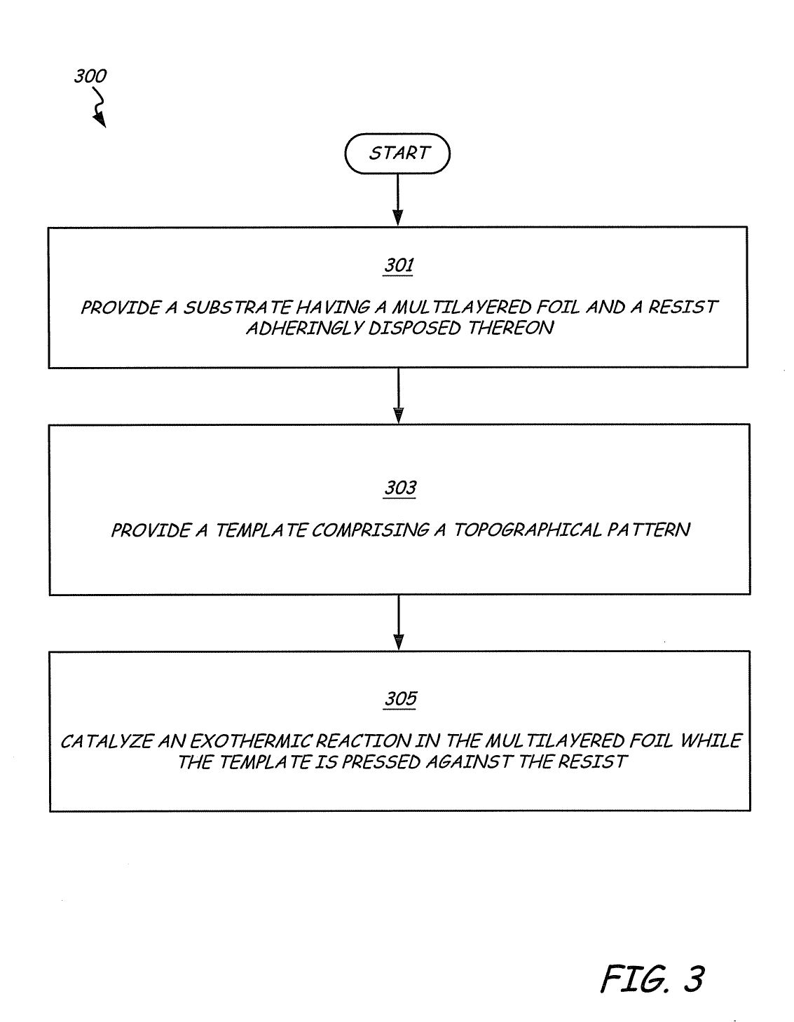

FIG. 3 depicts a flowchart for a method 300 according to another illustrative embodiment, which also makes use of a multilayered foil as a heat source, where the multilayered foil is capable of exothermic reaction. Method 300 includes step 301, of providing a substrate having a multilayered foil and a resist adheringly disposed thereon; step 303, of providing a template comprising a topographical pattern; and step 305, of catalyzing an exothermic reaction in the multilayered foil while the template is pressed against the resist. In method 300, the substrate, multilayered foil, resist, and template may be similar or analogous to those depicted in FIG. 1, generally as discussed above.

The exothermic reaction in the multilayered foil may be catalyzed by applying a voltage through the multilayered foil, in this embodiment. The exothermic reaction in the multilayered foil is sufficient to enable deformation of the resist, such as by melting it and allowing it to flow into conformity with the topographical pattern on the template, and allowing it to resolidify in that topography.

The exothermic reaction also provides this heat with limited energy and rapid diffusion such that it does not substantially raise the temperature of a portion of the template, such as the portion of the template disposed distally away from the portion of the template that is topographically patterned and that is in immediate proximity to the area of contact with the resist. The portion of the template that does not have its temperature significantly raised may potentially include a majority of the bulk of the template. This acts to keep the application of heat localized, and thereby to restrain the potential for thermal mismatches or gradients across the template, which could otherwise induce differential contractions during cooling and resulting imprecisions and deformities in the topographic pattern imprinted on the resist. Some additional details of the mechanism of the exothermic reaction, and its capability for rapid application of sufficient heat to imprint the resist and similarly rapid diffusion of that heat, are provided as follows.

The multilayered foil may be deposited on the substrate prior to the resist being deposited on the substrate. The multilayered foil may be deposited on the substrate through any of a variety of methods, such as magnetron sputtering deposition, in an illustrative example. The multilayered foil may be deposited in a series of thin, alternating layers of different substances. For example, this may include aluminum and nickel, each of which may be sputter deposited onto a rotating silicon substrate, with the sputter deposition alternating rapidly between the aluminum and the nickel, to overlay them in a series of layers to generate the multilayered foil.

During a fabrication processing step, as shown at processing stage 101B in FIG. 1, the template 107 is pressed against the resist 105 while the multilayered foil 103 is ignited by a voltage delivered by electrical leads 111, 113, triggering an exothermic reaction across the disc of the multilayered foil. This exothermic reaction involves the atomic aluminum and the atomic nickel in the multilayered foil reacting together, mainly transforming into a final phase form of non-magnetic Al₃Ni₂, which is the lowest-enthalpy, equilibrium phase of the combination.

During preparation of the multilayered foil, the elemental aluminum and elemental nickel may be deposited in layers of unequal thickness that provide a number density ratio of three aluminum atoms per two nickel atoms in adjacent layers, within nominal fabrication tolerances. This number density ratio helps optimize the reaction of the two metals into the final phase of Al₃Ni₂, by ensuring that there isn't a significant imbalance of one or the other materials relative to the final phase, where such an imbalance would result in extra atoms of the over-represented species unable to contribute to heating and obstructing the production of heat by the surrounding reactions, thereby lowering the efficiency and speed of the production of heat in the multilayered foil.

The initially heterogeneous, alternating layers of the multilayered foil react together into a relatively homogeneous, alloyed, single layer in the final phase of Al₃Ni₂, although other reaction products may also occur in smaller amounts. This reaction of atomic aluminum and atomic nickel into the Al₃Ni₂ alloy releases the difference in enthalpy between the initial atomic layers and the final phase in a rapid burst of heat, which then diffuses away with similar rapidity.

This sudden flash of heat is sufficient to melt the resist 105 while it is under pressure from template 107, causing the resist 105 to assume the topographical pattern imprinted on it by template 107. Because the heat diffuses away very rapidly, it never has a chance to penetrate a significant distance into the body of the template 107, and the resist 105 also cools back down and re-solidifies rapidly, in its new pattern.

The applicants have found that while a typical thermal imprinting process may require several minutes for the resist to cool and solidify, before the template can be removed and subsequent processing steps performed, an imprinting process according to one of the illustrative embodiments disclosed herein may require only five seconds or less to accomplish the same cooling and solidification. These illustrative embodiments also enable sufficient precision for the imprinting process to form features with dimensions on a scale of the very low tens of nanometers or smaller.

Certain aspects of the preparation of the multilayered foil may help optimize the speed with which it generates and then diffuses away the heat it generates. For example, multilayered foils are sometimes annealed, which increases the amount of preemptively formed alloy in intermix layers that form between the individual aluminum and nickel layers. Generally, increasing the presence of metals that are already alloyed in the intermix layers decreases the speed of the subsequent exothermic reaction. In one illustrative embodiment, a very short reaction time is promoted by avoiding annealing of the multilayered foil, and taking precautions while applying the alternating layers to prevent preemptive alloying and to keep the intermix layers as thin as possible relative to the atomic metal layers. In an illustrative example, ensuring that less than five percent of the aluminum and nickel is in a preemptively alloyed phase in the multilayered foil helps optimize the speed of the exothermic reaction.

In another illustrative example, the thickness of each of the bilayers within the multilayered foil is tailored for a fast reaction time. One bilayer comprises one layer of the first element and one adjacent layer of the second element. For example, dealing with the illustrative example of aluminum and nickel as the two reactant materials, depositing the aluminum and nickel with a bilayer thickness of between 5 and 40 nanometers promotes the fastest reaction times, and particularly between 10 and 15 nanometers.

As indicated, a very wide variety of other materials may also be used in other embodiments for the alternating layers in the exothermically reacting multilayered foil, including a wide variety of transition metals and light elements. As illustrative examples, other transition metals besides nickel may be used, such as titanium, vanadium, chromium, manganese, iron, cobalt, copper, zirconium, molybdenum, rhodium, palladium, silver, tungsten, or any other transition metal. Other light elements besides aluminum may also be used for the opposing layers, which may illustratively include magnesium, among other options.

More than one transition metal and more than one light metal may also be combined in one multilayered foil. The multilayered foil is also not limited to a transition metal and a light element; any other set of exothermically reacting materials may also be used in other embodiments. In still other embodiments, other heat sources may be used adjacent to the resist, such as a thin-film resistive heater, which may also be able to deliver a similar rapid, localized burst of heat in the immediate vicinity of the resist and the topographically patterned portion of the template in contact with the resist.

Various embodiments such as those illustratively disclosed herein therefore provide unexpected and novel advantages as detailed herein and as can be further appreciated by those skilled in the art from the claims, figures, and description provided herein. Different embodiments such as those illustratively disclosed herein may be used in the fabrication of a very broad range of different devices, illustratively including patterned media for magnetic recording devices, microprocessors, integrated circuits, transducer heads, memory chips, micro-electro-mechanical devices, or any other types of fabricated components.

It is to be understood that even though numerous characteristics and advantages of various illustrative embodiments of the invention have been set forth in the foregoing description, together with details of the structure and function of various embodiments of the invention, this disclosure is illustrative only, and changes may be made in detail, especially in matters of structure and arrangement of parts within the principles of the present invention, to the full extent indicated by the broad, general meaning of the terms in which the appended claims are expressed. It will be appreciated by those skilled in the art that the teachings of the present invention can be applied to a family of systems, devices, and means encompassed by and equivalent to the examples of embodiments described, without departing from the scope and spirit of the present invention.

What is claimed is:

1. A method comprising:
providing a substrate having a resist adheringly disposed thereon;
providing a heat source adjacent to the resist; and
activating the heat source while providing a topographically patterned template pressed against the resist, wherein the heat source and the resist are disposed between the substrate and the template, such that the heat source provides a localized application of heat to the resist while the topographically patterned template is pressed against the resist.

2. The method of claim 1, wherein the heat source is disposed between the substrate and the resist.

3. The method of claim 1, wherein the heat source comprises a multilayered foil composed of two or more substances that are capable of reacting with each other exothermically.

4. The method of claim 3, wherein the method further comprises igniting an exothermic reaction in the multilayered foil by applying a voltage to the multilayered foil.

5. The method of claim 3, wherein the multilayered foil comprises a transition metal and a light element.

6. The method of claim 3, wherein the multilayered foil comprises aluminum and nickel.

7. The method of claim 6, wherein the aluminum and nickel are deposited in layers of unequal thickness that provide a number density ratio of 3 aluminum atoms per 2 nickel atoms, within nominal fabrication tolerances.

8. The method of claim 3, wherein less than five percent of the aluminum and the nickel in the multilayered foil is comprised in an alloyed phase prior to activating the heat source.

9. The method of claim 3, wherein the multilayered foil is provided with a thickness that provides for the application of heat to have a temperature capable of melting the resist, without significantly raising the temperature of a portion of the template disposed distally from a portion of the template that is topographically patterned.

10. The method of claim 3, wherein the multilayered foil is deposited with a bilayer thickness of between 5 and 40 nanometers.

11. The method of claim 1, wherein the heat source comprises a thin-film resistive heater.

12. The method of claim 1, wherein the heat source is deposited on the substrate prior to the resist being disposed on the substrate.

13. The method of claim 1, wherein the substrate comprises at least one of glass, aluminum, or silicon.

14. The method of claim 1, wherein the substrate is comprised in a wafer, wherein the method further comprises separating the topographically patterned template from the resist and performing further processing steps on the wafer, the further processing steps comprising one or more of: descumming, etching, deposition, planarization, lithography, doping, and annealing.

15. A method comprising:
providing a substrate having a multilayered foil and a resist adheringly disposed thereon;
providing a template comprising a topographical pattern; and
catalyzing an exothermic reaction in the multilayered foil while the template is pressed against the resist.

16. The method of claim 15, wherein the exothermic reaction in the multilayered foil is sufficient to enable deformation of the resist to conform to the topographical pattern, without substantially raising the temperature of a portion of the template.

17. The method of claim 15, wherein catalyzing the exothermic reaction in the multilayered foil comprises applying a voltage through the multilayered foil.

18. A system comprising:
a substrate having a multilayered foil and a resist adheringly disposed thereon, wherein the multilayered foil is composed of two or more substances that are capable of reacting with each other exothermically;
a template comprising a topographical pattern;
a positioning component configured to press the template into contact with the resist; and
electrical leads positioned to contact the multilayered foil while the template is being pressed into contact with the resist.

19. The system of claim 18, wherein the multilayered foil comprises a transition metal and a light element.

20. The system of claim 18, wherein the multilayered foil comprises aluminum and nickel.
